(19) United States
(12) Patent Application Publication
(10) Pub. No.: US 2025/0379294 A1
(43) Pub. Date: Dec. 11, 2025

(54) PRISMATIC BATTERY

(71) Applicant: Prime Planet Energy & Solutions, Inc., Tokyo (JP)

(72) Inventors: Yusuke ITOH, Kobe-shi (JP); Naoto ONODERA, Kobe-shi (JP)

(21) Appl. No.: 19/224,905

(22) Filed: Jun. 2, 2025

(30) Foreign Application Priority Data
Jun. 10, 2024 (JP) 2024-093379

(51) Int. Cl. H01M 50/103; H01M 4/587; H01M 50/15

(52) U.S. Cl. CPC H01M 50/103; H01M 4/587; H01M 50/15

(57) ABSTRACT

The present disclosure provides a prismatic battery that includes a laminated electrode assembly having positive electrode plates and negative electrode plates. The negative electrode plate has a negative electrode active material layer including a Si-containing material. The negative electrode active material layer has a closing plate side region provided at one end portion thereof on the closing plate side and a central region provided in a band shape at a center thereof in a first direction. The closing plate side region is free of the Si-containing material or has a content of the Si-containing material lower than that in the central region.

### CROSS REFERENCE TO RELATED APPLICATION

This application claims the benefit of priority to Japanese Patent Application No. 2024-093379 filed on Jun. 10, 2024. The entire contents of this application are hereby incorporated herein by reference.

### BACKGROUND OF THE DISCLOSURE

### 1. Field

The present disclosure relates to a prismatic battery.

### 2. Background

Conventionally, there is a known electricity storage device including: a case having a case body with an opening and a closing plate closing the opening; and an electrode assembly housed inside the case (see, for example, Japanese Patent Application Publication No. 2006-040684 and International Publication No. 2021/261358).

### SUMMARY

As described, for example, in Japanese Patent Application Publication No. 2006-040684, the electrode assembly may expand due to its repetitive charging and discharging or the like. At this time, in a prismatic battery with a rectangular case, a pressure applied to the case tends to become non-uniform, with relatively greater pressure being more likely to be applied to surfaces with larger areas. Therefore, the case of the prismatic battery is more susceptible to deformation and damage than, for example, a cylindrical battery or a laminated battery.

Further, according to the inventors' findings, in recent years, from the viewpoint of improving energy density and the like, the outer shape of the electrode assembly has been designed to be substantially the same size as the internal dimensions of the case. In particular, unlike a wound electrode assembly, a laminated electrode assembly does not have a curved portion (R portion), and thus tend to press strongly against the corners of the case when it expands due to its repetitive charging and discharging or the like. When a negative electrode plate particularly contains a Si-containing material from the viewpoint of high capacity, the expansion of the laminated electrode assembly becomes more remarkable. This causes a problem in which the pressure tends to concentrate especially on a joint between the case body and the closing plate.

The present disclosure has been made in view of the above circumstances, and its main object is to provide a prismatic battery where pressure is less likely to concentrate on a joint of a case.

According to the present disclosure, a prismatic battery is provided which includes: a rectangular case including a case body that includes a first surface having a substantially rectangular shape with a pair of long sides and a pair of short sides, a pair of second surfaces extending from the respective pair of long sides, the second surface having a larger area than the first surface, and one or more openings, and one or more closing plates that close the one or more openings; and a laminated electrode assembly housed inside the case and having a positive electrode plate and a negative electrode plate that are disposed substantially in parallel with the second surface. The negative electrode plate has a negative electrode active material layer including a Si-containing material as a negative electrode active material. The negative electrode active material layer has one or more closing plate side regions provided in a band shape at one or more end portions thereof on the closing plate side, and a central region provided in a band shape at a center thereof in a first direction orthogonal to the closing plate. The closing plate side region is free of the Si-containing material, or has a content of the Si-containing material lower than that in the central region.

In the present disclosure, the closing plate side region of the negative electrode plate is free of the Si-containing material or has the content of the Si-containing material lower than that in the central region. This can suppress the concentration of the pressure on a joint between the case body and the closing plate of the case. Furthermore, damage to the joint is suppressed. In addition, by relatively increasing the content of the Si-containing material in the central region of the negative electrode plate, the energy density can be improved.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view schematically illustrating a prismatic battery 100 according to one embodiment.

FIG. 2 is a schematic longitudinal-sectional view, taken along the line II-II in FIG. 1.

FIG. 3 is a schematic plan view of a negative electrode plate.

FIG. 4 is a diagram, corresponding to FIG. 1, according to a variant.

FIG. 5 is a schematic longitudinal-sectional view, taken along the line V-V in FIG. 4.

FIG. 6 is a diagram, corresponding to FIG. 3, according to another variant.

### DETAILED DESCRIPTION OF THE PREFERRED EMBODIMENTS

Hereinafter, preferred embodiments of the technology disclosed herein will be described with reference to the drawings as appropriate. Matters that are necessary for carrying out the technology disclosed herein, but are not specifically mentioned in the present specification (e.g., general configurations and manufacturing processes of prismatic batteries that do not characterize the technology disclosed herein) may be understood by those skilled in the art as design matters based on technologies in the related art of the same field. The technology disclosed herein can be implemented based on the contents disclosed in the present specification and the technical common knowledge in the field. In the present specification, the notation “A to B” indicating a range includes the meanings of “preferably greater than A” and “preferably less than B” as well as the meanings of A or more and B or less.

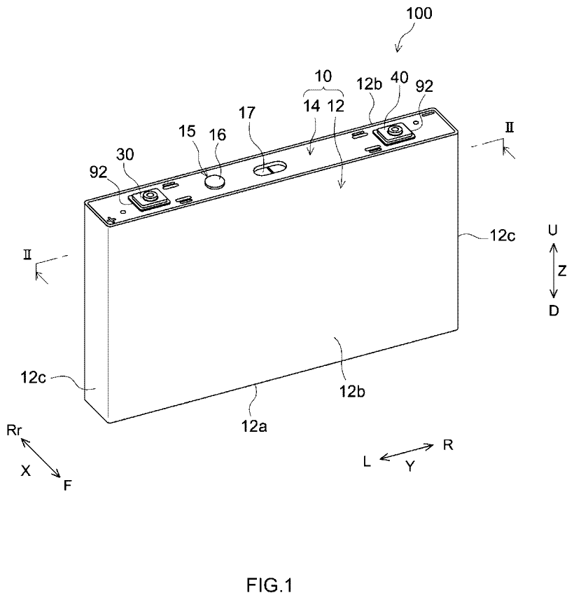

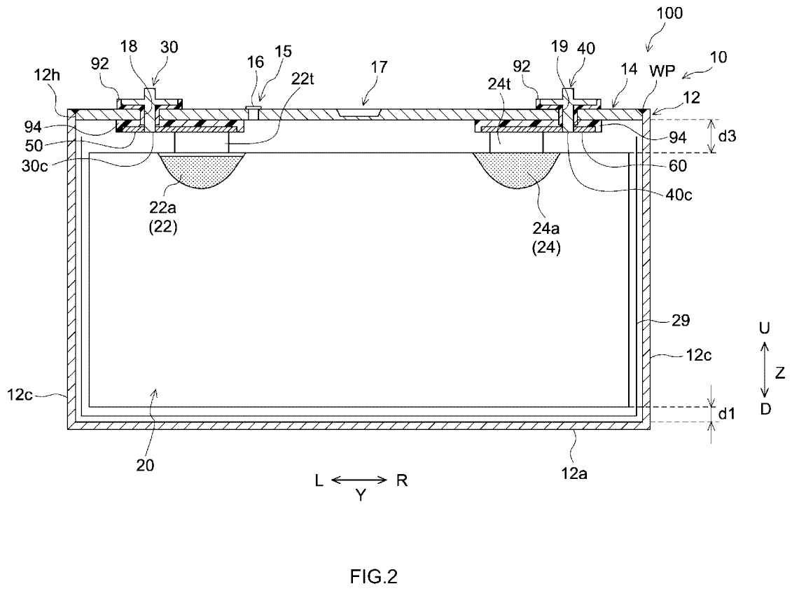

FIG. 1 is a perspective view of a prismatic battery 100. FIG. 2 is a schematic longitudinal-sectional view, taken along the line II-II in FIG. 1. In the following description, members and parts that have the same actions are denoted by the same symbols, and redundant explanations thereof may be omitted or simplified. Signs F, Rr, L, R, U, and D in the drawings represent front, rear, left, right, up, and down, respectively, and signs X, Y, and Z in the drawings represent a short side direction (thickness direction) of the prismatic battery 100, a long side direction orthogonal to the short side direction, and an up-down direction orthogonal to the short side direction and long side direction, respectively. The up-down direction Z is typically coincident with the vertical direction. However, these directions are only for convenience of explanation and do not limit the installation form of the prismatic battery 100 in any way.

As illustrated in FIG. 2, the prismatic battery 100 includes a rectangular case 10, a laminated electrode assembly 20, a positive electrode terminal 30, and a negative electrode terminal 40. Although not illustrated in the drawings, the prismatic battery 100 here further includes an electrolyte solution. The prismatic battery 100 is here a secondary battery. In detail, it is a non-aqueous electrolyte secondary battery. The prismatic battery 100 is preferably a lithium ion secondary battery. The term “secondary battery” as used in the present specification refers to general electricity storage devices that can be repeatedly charged and discharged, and is a concept that encompasses secondary batteries such as lithium-ion secondary batteries and nickel metal hydride batteries, as well as capacitors that utilize chemical reactions such as lithium-ion capacitors and pseudo-capacitors.

The case 10 is a housing that houses the laminated electrode assembly 20 and the electrolyte solution therein. As illustrated in FIG. 1, the case 10 has a flat cuboidal (rectangular) outer shape with a bottom. The case 10 has a size according to the size of the laminated electrode assembly 20 or the like. The material of the case 10 may be the same as that conventionally used and is not particularly limited. The case 10 is preferably made of metal, for example, more preferably aluminum, an aluminum alloy, iron, an iron alloy, etc.

As illustrated in FIG. 2, in the present embodiment, the case 10 includes a bottomed square (box-shaped) case body 12 having an opening 12h on one surface (here, an upper surface) and a closing plate (lid) 14 that closes the opening 12h of the case body 12. Here, a single opening 12h of the case body 12 and a single closing plate 14 are provided. The case body 12 and the closing plate 14 in the case 10 are integrated by joining the closing plate 14 to the peripheral edge of the opening 12h of the case body 12. In the present embodiment, the case body 12 and the closing plate 14 are integrated by welding a seam between the case body 12 and the closing plate 14, for example, through laser welding. A joint (in detail, a weld joint WP) is formed at the peripheral edge of the opening 12h of the case body 12, in detail, at a boundary between the closing plate 14 and each of a long side surface 12b (second surface, see FIG. 1) and a short side surface 12c of the case body 12, which are described later. The case 10 is hermetically sealed (made airtight).

As illustrated in FIG. 1, the case body 12 has a substantially rectangular bottom surface 12a with a pair of long sides and a pair of short sides, the pair of long side surfaces 12b extending from the pair of long sides of the bottom surface 12a and opposed to each other, and the pair of short side surfaces 12c extending from the respective pair of short sides of the bottom surface 12a and opposed to each other. The bottom surface 12a is opposed to the closing plate 14. The bottom surface 12a is an example of a “first surface”. The long side surface 12b is a surface with the largest area. That is, the long side surface 12b has a larger area than the bottom surface 12a. The long side surface 12b has a larger area than the short side surface 12c. The long side surface 12b is an example of the “second surface”.

In the present specification, “substantially rectangular shape” is a term that encompasses not only a perfect rectangular shape (rectangle shape), but also a shape with an R-shaped corner connecting the long and short sides of a rectangle, a shape with a notch in the corner, for example, and the like.

The closing plate 14 is a plate-shaped member that closes the opening 12h of the case body 12. The closing plate 14 here is opposed to the bottom surface 12a (first surface) of the case body 12. The closing plate 14 has a substantially rectangular shape. As illustrated in FIG. 2, the closing plate 14 is provided with a pouring hole 15, a gas discharge valve 17, and two terminal drawout holes 18 and 19. The pouring hole 15 is a through hole for pouring an electrolyte solution into the case 10 after the closing plate 14 is assembled to the case body 12. The pouring hole 15 is sealed by a sealing member 16 after pouring the electrolyte solution. The gas discharge valve 17 is configured to rupture when the pressure inside the case 10 reaches a predetermined value or higher, thereby releasing the internal pressure of the case 10 to the outside. The terminal drawout holes 18 and 19 are formed at both respective ends of the closing plate 14 in its long side direction Y. The terminal drawout holes 18 and 19 each penetrate the closing plate 14 in the up-down direction Z.

The positive electrode terminal 30 is disposed at one end portion of the closing plate 14 in the long side direction Y (left end portion in FIGS. 1 and 2). As illustrated in FIG. 2, the positive electrode terminal 30 extends from the inside to the outside of the closing plate 14 through the terminal drawout hole 18. The positive electrode terminal 30 is here caulked and fixed to a peripheral edge portion of the closing plate 14 that surrounds the terminal drawout hole 18 by a caulking process. A caulking portion 30c is formed at an end portion of the positive electrode terminal 30 on the case body 12 side (lower end portion in FIG. 2). The positive electrode terminal 30 is electrically connected to positive electrode plates 22 of the laminated electrode assembly 20 inside the case 10 via a positive electrode current collector member 50 and positive electrode tabs 22t, which will be described later. The positive electrode terminal 30 is preferably made of metal, for example, more preferably aluminum or an aluminum alloy. The positive electrode terminal 30 is insulated from the closing plate 14 by a gasket 92 and an internal insulating member 94.

The negative electrode terminal 40 is disposed at the other end portion of the closing plate 14 in the long side direction Y (right end portion in FIGS. 1 and 2). As illustrated in FIG. 2, the negative electrode terminal 40 extends from the inside to the outside of the closing plate 14 through the terminal drawout hole 19. The negative electrode terminal 40 is here caulked and fixed to a peripheral edge portion of the closing plate 14 that surrounds the terminal drawout hole 19 by the caulking process. A caulking portion 40c is formed at an end portion of the negative electrode terminal 40 on the case body 12 side (lower end portion in FIG. 2). The negative electrode terminal 40 is electrically connected to negative electrode plates 24 of the laminated electrode assembly 20 inside the case 10 via a negative electrode current collector member 60 and negative electrode tabs 24t, which will be described later. The negative electrode terminal 40 is preferably made of metal, for example, more preferably copper or a copper alloy. The negative electrode terminal 40 is insulated from the closing plate 14 by the gasket 92 and the internal insulating member 94.

The electrolyte solution is housed inside the case 10. The material of the electrolyte solution may be the same as that conventionally used and is not particularly limited. The electrolyte solution is typically a non-aqueous electrolyte solution that contains a non-aqueous solvent and a supporting salt (electrolyte salt). However, in other embodiments, the electrolyte solution may be an aqueous electrolyte solution that contains an aqueous solvent. Examples of non-aqueous solvents include carbonates such as ethylene carbonate, dimethyl carbonate, and ethyl methyl carbonate. Examples of supporting salts include fluorine-containing lithium salts such as lithium hexafluorophosphate (LiPF₆). The electrolyte solution may further contain an additive as needed. In other embodiments, the electrolyte solution may be in solid form (solid electrolyte) and integrated with the laminated electrode assembly 20.

As illustrated in FIG. 2, the laminated electrode assembly 20 is housed inside the case 10. The laminated electrode assembly 20 here is housed inside the case 10 while being covered with a resin insulating sheet (electrode assembly holder) 29. The laminated electrode assembly 20 is disposed relatively on the lower side (bottom surface 12a (first surface) side) inside the case 10 by having the positive electrode tabs 22t and the negative electrode tabs 24t. In other words, a gap d1 between the bottom surface 12a (first surface) and a lower end of the laminated electrode assembly 20 is smaller than a gap d3 between the closing plate 14 and an upper end of the laminated electrode assembly 20 (i.e., d1<d3).

The laminated electrode assembly 20 has the positive electrode plate 22 and the negative electrode plate 24 disposed (stacked) substantially in parallel with the long side surface 12b (second surface) of the case 10. The laminated electrode assembly 20 typically has a plurality of positive electrode plates 22 and a plurality of negative electrode plates 24. Each of the positive electrode plate 22 and the negative electrode plate 24 here has a substantially rectangular (in detail, perfect rectangular) shape. The positive electrode plate 22 and the negative electrode plate 24 are arranged such that the long side thereof is aligned along the long side direction Y, while the short side thereof is aligned along the up-down direction Z. The positive electrode plate 22 and the negative electrode plate 24 are insulated from each other through a separator or the like, which is not illustrated, and opposed to each other in the short side direction X (in the laminating direction).

In the present specification, “substantially parallel” is a term that does not mean parallel in the strict sense of the word, but allows an inclination of several degrees. For example, it means that an angle formed between the direction in which the long side surface 12b (second surface) extends and the direction in which the positive electrode plate 22 or negative electrode plate 24 extends is 10° or less (preferably 5° or less).

The positive electrode plate 22 has the positive electrode tab 22t protruding toward the closing plate 14 side and a positive electrode active material layer 22a. The positive electrode tab 22t protrudes upward from the laminated electrode assembly 20. The positive electrode tab 22t is here a part of a positive electrode current collector. In detail, the positive electrode tab 22t is a convex part where the positive electrode active material layer 22a is not formed and the positive electrode current collector is exposed. The positive electrode tab 22t is here electrically connected to the positive electrode terminal 30 via the positive electrode current collector member 50. The positive electrode tab 22t (positive electrode current collector) is preferably made of a metal foil and particularly preferably an aluminum foil or an aluminum alloy foil. However, in other embodiments, the positive electrode tab 22t may be a separate member from the positive electrode plate 22.

The positive electrode active material layer 22a is adhered to at least one surface (preferably both surfaces) of the positive electrode current collector in the short side direction X. The configuration of the positive electrode active material layer 22a may be the same as a conventional one and is not particularly limited. The positive electrode active material layer 22a contains a positive electrode active material that can reversibly absorb and release charge carriers. A lithium transition metal composite oxide is preferable as the positive electrode active material, and one example thereof is a lithium nickel cobalt manganese composite oxide. The positive electrode active material layer 22a may contain optional components in addition to the positive electrode active material, such as a conductive material, a positive electrode binder, and various additive components, for example. As the conductive material, carbon materials such as acetylene black (AB), for example, are preferable. As the positive electrode binder, polyvinylidene fluoride (PVdF), for example, is preferable.

The negative electrode plate 24 has the negative electrode tab 24t protruding toward the closing plate 14 side and a negative electrode active material layer 24a. The negative electrode tab 24t protrudes upward from the laminated electrode assembly 20. The negative electrode tab 24t is here a part of a negative electrode current collector. In detail, the negative electrode tab 24t is a convex portion where the negative electrode active material layer 24a is not formed and the negative electrode current collector is exposed. The negative electrode tab 24t is here electrically connected to the negative electrode terminal 40 via the negative electrode current collector member 60. The negative electrode tab 24t (negative electrode current collector) is preferably made of a metal foil, and particularly preferably a copper foil or a copper alloy foil. However, in other embodiments, the negative electrode tab 24t may be a separate member from the negative electrode plate 24.

The negative electrode active material layer 24a is adhered to at least one surface (preferably both surfaces) of the negative electrode current collector in the short side direction X. The configuration of the negative electrode active material layer 24a may be the same as a conventional one and is not particularly limited. The negative electrode active material layer 24a contains a negative electrode active material that can reversibly absorb and release charge carriers. The negative electrode active material layer 24a contains at least a Si-containing material as the negative electrode active material. The Si-containing material may be Si or a silicon-containing compound such as silicon oxide, silicon carbide, or silicon nitride. The negative electrode active material layer 24a preferably further contains a carbon material such as graphite, as the negative electrode active material. The graphite may be natural graphite, artificial graphite, or amorphous carbon-coated graphite, in which graphite particles serving as cores are coated with an amorphous carbon material.

The negative electrode active material layer 24a may contain optional components in addition to the negative electrode active material, such as a negative electrode binder, a conductive material, and various additive components, for example. As the negative electrode binder, for example, rubbers such as styrene butadiene rubber (SBR) and celluloses such as carboxymethyl cellulose (CMC) are preferable. Carbon materials are preferable as the conductive material.

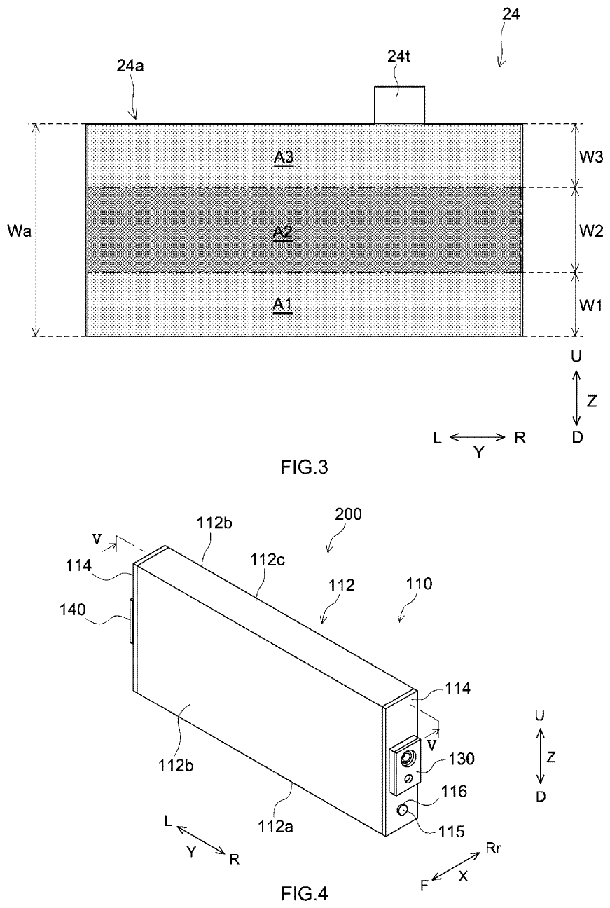

FIG. 3 is a schematic plan view of the negative electrode plate 24. As illustrated in FIG. 3, the negative electrode active material layer 24a has a plurality of portions with different compositions in the up-down direction Z. The up-down direction Z is an example of a “first direction orthogonal to the closing plate”. In the present embodiment, the negative electrode active material layer 24a is divided into three regions in the up-down direction Z, namely, a closing plate side region A3, a central region A2, and a bottom surface side region A1. However, in other embodiments, the negative electrode active material layer 24a (electrode active material layer) may further have another region(s) (fourth region and/or fifth region), for example, between the bottom surface side region A1 and the central region A2, or between the closing plate side region A3 and the central region A2. The closing plate side region A3 is a band-shaped region provided in an end portion (upper end portion) on the closing plate 14 side. The central region A2 is a band-shaped region provided at the center in the up-down direction Z. The central region A2 is a region including the center of the negative electrode active material layer 24a in the up-down direction Z (first direction). The central region A2 is here a region provided between the bottom surface side region A1 and the closing plate side region A3. The bottom surface side region A1 is a band-shaped region provided in an end portion (lower end portion) on the bottom surface 12a (first surface) side. The bottom surface side region A1 is an arbitrary region and does not need to be provided, as described, for example, in a variant described later. The bottom surface side region A1 is an example of a “first surface side region”.

In some embodiments, it is preferred that the respective regions of the negative electrode active material layer 24a (here, the closing plate side region A3, the central region A2, and the bottom surface side region A1) all have substantially the same properties (e.g., density and thickness). In the present specification, “density” refers to a solid content per unit volume (g/cm³) of the negative electrode active material layer 24a. The density can be determined by dividing the mass of the negative electrode active material layer 24a by an apparent volume of the negative electrode active material layer 24a.

In the present embodiment, the closing plate side region A3 is free of a Si-containing material, or alternatively the content of the Si-containing material (proportion of the Si-containing material) in the closing plate side region A3 is lower than that in the central region A2. The laminated electrode assembly 20 expands in the short side direction X (laminating direction) due to repetitive charging and discharging or the like. According to the inventors' findings, the expansion of the laminated electrode assembly 20 becomes greater as the content of the Si-containing material increases. Therefore, in the technology disclosed herein, the content of the Si-containing material in the closing plate side region A3 of the negative electrode plate 24 is set to be relatively low. This suppresses the concentration of the pressure on the weld joint WP between the case body 12 and the closing plate 14 of the case 10. Furthermore, damage to the weld joint WP of the case 10 is suppressed. In addition, by relatively increasing the content of the Si-containing material in the central region A2 of the negative electrode plate 24, the area weight per single cell of the prismatic battery 100 can be relatively increased, thus improving the energy density.

In some embodiments, the bottom surface side region A1 (first surface side region) is free of the Si-containing material, or alternatively the content of the Si-containing material is lower than that in the central region A2. This suppresses the concentration of pressure on the boundary (lower corner) between the long side surface 12b (second surface) and the bottom surface 12a (first surface) of the case 10. Furthermore, deformation and damage of the case 10 can be better suppressed.

In the present embodiment, the negative electrode active material layer 24a further contains graphite as the negative electrode active material, and the closing plate side region A3 preferably has a higher graphite content than the central region A2. Furthermore, the bottom surface side region A1 preferably has a higher graphite content than the central region A2. This can mitigate the difference in the level of a charge-discharge reaction among the respective regions of the negative electrode active material layer 24a.

The closing plate side region A3 may contain the Si-containing material or may be free of the Si-containing material. The negative electrode active material of the closing plate side region A3 may contain, for example, the Si-containing material and graphite, or may be composed of only graphite. From the viewpoint of high capacity, the closing plate side region A3 more preferably contains the Si-containing material, and even more preferably the Si-containing material and graphite. Although not particularly limited, in the closing plate side region A3, the content of the Si-containing material in the total negative electrode active material is preferably less than 20 mass %, more preferably 1 to 18 mass %, and even more preferably 5 to 15 mass %. By setting the content of the Si-containing material to be less than or equal to a predetermined value, the pressure is further less likely to concentrate on the weld joint WP of the case 10, thereby exhibiting the effects of the technology disclosed herein at a high level. In addition, by setting the content of the Si-containing material to be greater than or equal to a predetermined value, the high energy density of the prismatic battery 100 can be achieved.

In the closing plate side region A3, the graphite content in the total negative electrode active material is preferably greater than the content of the Si-containing material. It is more preferably 50 mass % or more, even more preferably 80 to 100 mass %, and particularly preferably 85 to 95 mass %.

The central region A2 contains the Si-containing material as essential. The negative electrode active material of the central region A2 may contain, for example, the Si-containing material and graphite, or may be composed of only the Si-containing material. Although not particularly limited, in the central region A2, the content of the Si-containing material in the total negative electrode active material is preferably 20 mass % or more, more preferably 20 to 60 mass %, for example, 50 mass % or less, and even more preferably 20 to 30 mass %. By setting the content of the Si-containing material to be the predetermined value or more, the high energy density of the prismatic battery 100 can be achieved. Also, by setting the content of the Si-containing material to be more than or equal to the predetermined value, strong pressure becomes less likely to be applied to the long side surface 12b (second surface) of the case 10, so that deformation and damage of the case 10 can be better suppressed, thereby exhibiting the effects of the technology disclosed herein at a high level.

In the central region A2, the graphite content in the total negative electrode active material is preferably greater than that of the Si-containing material, more preferably 40 mass % or more, even more preferably 40 to 80 mass %, for example, 50 mass % or more, and particularly preferably 70 to 80 mass %.

The bottom surface side region A1 may contain the Si-containing material or may be free of the Si-containing material. The negative electrode active material of the bottom surface side region A1 may contain, for example, the Si-containing material and graphite, or may be composed of only graphite. From the viewpoint of high capacity, the bottom surface side region A1 more preferably contains the Si-containing material, and even more preferably the Si-containing material and graphite. The content of the Si-containing material in the bottom surface side region A1 may be the same or different from that in the closing plate side region A3. Although not particularly limited, in the bottom surface side region A1, the content of the Si-containing material in the total negative electrode active material is preferably less than 20 mass %, more preferably 1 to 18 mass %, and even more preferably 5 to 15 mass %. By setting the content of the Si-containing material to be less than or equal to the predetermined value, the pressure further becomes less likely to concentrate on the weld joint WP of the case 10, thereby exhibiting the effects of the technology disclosed herein at a high level. Further, by setting the content of the Si-containing material to be more than or equal to the predetermined value, the high energy density of the prismatic battery 100 can be achieved.

In the bottom surface side region A1, the graphite content in the total negative electrode active material is preferably greater than that of the Si-containing material, more preferably 50 mass % or more, even more preferably 80 to 100 mass %, and particularly preferably 85 to 95 mass %.

In each region of the negative electrode active material layer 24a (here, the closing plate side region A3, the central region A2, and the bottom surface side region A1), the proportion of the negative electrode active material is preferably 95 mass % or more of the total amount in the region, and more preferably 98 mass % or more. In this case, the content of the Si-containing material in the “total negative electrode active material”, which is described above, is substantially equal to the content of the Si-containing material in the entirety of each region. Therefore, in some embodiments, in the closing plate side region A3, the content of the Si-containing material in the total closing plate side region A3 is preferably less than 20 mass %, more preferably 1 to 18 mass %, and even more preferably 5 to 15 mass %. In the central region A2, the content of the Si-containing material in the total central region A2 is preferably 20 mass % or more, more preferably 20 to 60 mass %, and even more preferably 20 to 30 mass %. In the bottom surface side region A1, the content of the Si-containing material in the total bottom surface side region A1 is preferably less than 20 mass %, more preferably 1 to 18 mass %, and even more preferably 5 to 15 mass %.

Although not particularly limited, as illustrated in FIG. 3, when an entire width Wa of the negative electrode active material layer 24a is set to 100% in the up-down direction Z (first direction), a ratio W3 (%) of the width of the closing plate side region A3 and a ratio W1 (%) of the width of the bottom surface side region A1 are each preferably smaller than a ratio W2 (%) of the width of the central region A2 (i.e., W3<W2 and W1<W2). By suppressing the ratios W3 and W1 of the widths of the closing plate side region A3 and the bottom surface side region A1, which have relatively small Si-containing material contents, to a low level, the high energy density of the prismatic battery 100 can be achieved.

The ratio W3 of the width of the closing plate side region A3 and the ratio W1 of the width of the bottom surface side region A1 may be the same or different from each other. Although not particularly limited, each of the ratio W3 of the width of the closing plate side region A3 and the ratio W1 of the width of the bottom surface side region A1 is preferably 5% or more, and more preferably 10% or more. Thus, the pressure becomes less likely to concentrate on the corners of the long side surface 12b (second surface) of the case 10, so that deformation and damage of the case 10 are better suppressed. The ratio W3 of the width of the closing plate side region A3 is more preferable from 15 to 30%. The ratio W1 of the bottom surface side region A1 is more preferable from 10 to 30%. By setting each of the ratios W3 and W1 of the widths of the closing plate side region A3 and the bottom surface side region A1 to the predetermined value or less, the high energy density of the prismatic battery 100 can be achieved.

When the negative electrode active material layer 24a is divided into three regions as in the present embodiment, the ratio W2 of the width of the central region A2 can be calculated by the following formula: 100−(W1+W3). The ratio W2 of the width of the central region A2 is preferably greater than each of the ratio W1 of the width of the bottom surface side region A1 and the ratio W3 of the width of the closing plate side region A3. It is preferably 20% or more, more preferably 30% or more, even more preferably 40% or more, for example, 40 to 80%, and particularly preferably 40 to 75%. By setting the ratio W2 of the width of the central region A2 to be more than or equal to the predetermined value, the high energy density of the prismatic battery 100 can be achieved.

In some embodiments, when the laminated electrode assembly 20 is disposed relatively on the bottom surface 12a (first surface) side in the up-down direction Z (first direction), the ratio W1 of the width of the bottom surface side region A1 is preferably greater than the ratio W3 of the width of the closing plate side region A3 (i.e., W3<W1). Thus, the pressure becomes less likely to concentrate on the corners of the bottom surface 12a (first surface) in vicinity of the laminated electrode assembly 20, so that deformation and damage of the case 10 are better suppressed. In the negative electrode active material layer 24a, it is more preferable that the above ratios W1 to W3 of the widths satisfy W3<W1<W2. This can achieve both the effects of the technology disclosed herein and the high energy density at a higher level.

The prismatic battery 100 is usable for various applications. For example, it can be suitably used as power sources for motors (drive power sources) installed in vehicles such as passenger cars and trucks. The type of vehicle is not particularly limited, but examples thereof include plug-in hybrid electric vehicles (PHEVs), hybrid electric vehicles (HEVs), battery electric vehicles (BEVs), and the like.

The preferred embodiments of the present disclosure have been described above, but the above embodiments are illustrative only. The present disclosure can be implemented in various other forms. The present disclosure can be implemented based on the contents disclosed in the present specification and technical common sense in the field. The technology described in the claims includes various changes and modifications of the embodiments exemplified above. For example, it is possible to replace some of the above embodiments with other variants or to add other variants to the above embodiments. Those technical features can be deleted as appropriate unless otherwise described as essential.

For example, in the embodiments of FIGS. 1 and 2 described above, a single opening 12h of the case body 12 and a single closing plate 14 are provided. However, the present disclosure is not limited thereto. FIG. 4 is a diagram, corresponding to FIG. 1, according to a variant. FIG. 5 is a schematic longitudinal-sectional view, taken along the line V-V in FIG. 4. A prismatic battery 200 illustrated in FIGS. 4 and 5 includes a rectangular case 110, a laminated electrode assembly 120, a positive electrode terminal 130, and a negative electrode terminal 140. As illustrated in FIG. 5, the case 110 includes a prismatic tubular case body 112 with a pair (two) openings 112h at both ends thereof in the long side direction Y, and two closing plates 114 that close the pair of openings 112h in the case body 112. That is, in this variant, two openings 112h of the case body 112 and two closing plates 114 are provided.

As illustrated in FIG. 4, the case body 112 has a substantially rectangular bottom surface 112a (first surface) with a pair of long sides and a pair of short sides, a pair of long side surfaces 112b (second surface) extending from the pair of long sides of the bottom surface 112a and opposed to each other, and a top surface 112c opposed to the bottom surface 112a. The case body 112 is formed, for example, by folding a single metal sheet into a prismatic tubular shape and joining (for example, welding) a seam therebetween. Two closing plates 114 are provided to be opposed to each other so as to be orthogonal to the bottom surface 112a (first surface) and the long side surface 112b (second surface).

The positive electrode terminal 130 is provided on the first closing plate 114 (on the right side of FIGS. 4 and 5), while the negative electrode terminal 140 is provided on the second closing plate 114 (on the left side of FIGS. 4 and 5). An electrolyte solution pouring hole 115 is provided on the first closing plate 114 together with the positive electrode terminal 130. The electrolyte solution pouring hole 115 is sealed with a closing plug 116.

The laminated electrode assembly 120 includes positive electrode plates 122 and negative electrode plates 124, both types of which are housed inside the case 110 and disposed substantially in parallel with the long side surface 112b (second surface). The positive electrode plate 122 (positive electrode tab 122t) is electrically connected to the positive electrode terminal 130 via a positive electrode current collector member 150. The negative electrode plate 124 (negative electrode tab 124t) is electrically connected to the negative electrode terminal 140 via a negative electrode current collector member 160.

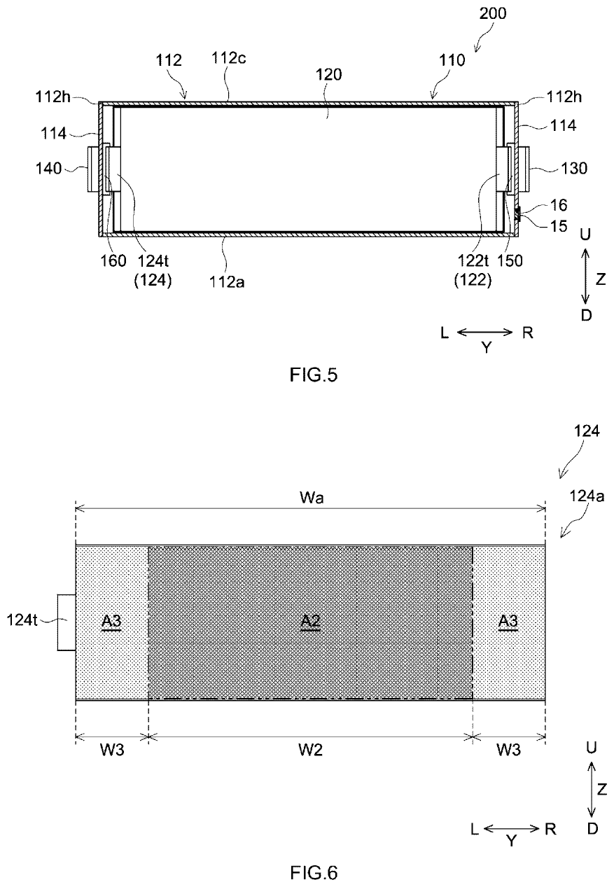

FIG. 6 is a diagram, corresponding to FIG. 3, according to another variant, and is a schematic plan view of the negative electrode plate 124. In this variant, the long side direction Y is a “first direction orthogonal to the closing plate”. As illustrated in FIG. 6, a negative electrode active material layer 124a of the negative electrode plate 124 is divided into closing plate side regions A3 and a central region A2. In the negative electrode plate 124, the closing plate side region A3 is provided at each of the end portion of the negative electrode plate 124 on the first closing plate 114 side (on the right side of FIGS. 4 and 5) and the end portion thereof on the second closing plate 114 side (on the left side of FIGS. 4 and 5). The central region A2 is a region including the center of the negative electrode active material layer 124a in the long side direction Y (first direction), and it is more preferably provided symmetrically with respect to the center of the long side direction Y as an axis.

Note that in the closing plate side region A3 and the central region A2, their compositions and the ratios W3 and W2 of the respective widths to the entire width Wa in the long side direction Y (first direction) may be substantially the same as those in the above embodiment. For example, when the entire width Wa of the negative electrode active material layer 124a in the long side direction Y (first direction) is 100%, the ratio W3 (%) of the width of each of the two closing plate side regions A3 is preferably smaller than the ratio W2 (%) of the width of the central region A2. The ratio W3 of the width of each of the two closing plate side regions A3 is more preferably 10% or more.

As described above, the specific aspects of the technology disclosed herein are those described in the following respective items.
Item 1: A prismatic battery including:
   a rectangular case including:
      a case body that has a first surface having a substantially rectangular shape with a pair of long sides and a pair of short sides; a pair of second surfaces extending from the respective pair of long sides, the second surface having a larger area than the first surface, and one or more openings; and
      one or more closing plates that close the one or more openings; and
   a laminated electrode assembly housed inside the case and having a positive electrode plate and a negative electrode plate that are disposed substantially in parallel with the second surface, wherein the negative electrode plate has a negative electrode active material layer including a Si-containing material as a negative electrode active material, the negative electrode active material layer has one or more closing plate side regions provided in a band shape at one or more end portions thereof on the closing plate side, and a central region provided in a band shape at a center thereof in a first direction orthogonal to the closing plate, and the closing plate side region is free of the Si-containing material or has a content of the Si-containing material lower than that in the central region.
Item 2. The prismatic battery according to Item 1, wherein the negative electrode active material layer further contains graphite as the negative electrode active material, and the closing plate side region has a content of the graphite higher than that in the central region.
Item 3. The prismatic battery according to Item 1 or 2, wherein in the closing plate side region, a proportion of the Si-containing material in the total negative electrode active material is less than 20 mass %, and in the central region, a proportion of the Si-containing material in the total negative electrode active material is 20 mass % or more.
Item 4. The prismatic battery according to any one of Items 1 to 3, wherein the one or more openings of the case body includes a single opening, while the one or more closing plates includes a single closing plate, the closing plate is opposed to the first surface, the negative electrode active material layer further has a first surface side region provided in a band shape at an end portion thereof on the first surface side, and the first surface side region is free of the Si-containing material or has a content of the Si-containing material lower than that in the central region.
Item 5. The prismatic battery according to Item 4, wherein when an entire width of the negative electrode active material layer in the first direction is 100%, a ratio of a width of the closing plate side region and a ratio of a width of the first surface side region are each smaller than a ratio of a width of the central region.
Item 6. The prismatic battery according to Item 4 or 5, wherein the ratio of the width of each of two of the closing plate side regions is 10% or more.
Item 7. The prismatic battery according to any one of Items 4 to 6, wherein the laminated electrode assembly is disposed closer to the first surface than the closing plate in the first direction, and the ratio of the width of the first surface side region is greater than the ratio of the width of the closing plate side region.
Item 8. The prismatic battery according to any one of Items 1 to 3, wherein the one or more openings of the case body include two openings, while the one or more number of the closing plates include two closing plates, the two closing plates are provided to be opposed to each other so as to be orthogonal to the first surface and the second surface, and the closing plate side region is provided at each of the end portion on a first closing plate side and the end portion on a second closing plate side.
Item 9. The prismatic battery according to Item 7, wherein when an entire width of the negative electrode active material layer in the first direction is 100%, a ratio of a width of each of two of the closing plate side regions is smaller than a ratio of a width of the central region.
Item 10. The prismatic battery according to Item 7 or 8, wherein the ratio of the width of each of two of the closing plate side regions is 10% or more.

What is claimed is:

1. A prismatic battery comprising:
a rectangular case comprising:
a case body that includes a first surface having a substantially rectangular shape with a pair of long sides and a pair of short sides, a pair of second surfaces extending from the respective pair of long sides, the second surface having a larger area than the first surface, and one or more openings; and
one or more closing plates that close the one or more openings; and
a laminated electrode assembly housed inside the case and including a positive electrode plate and a negative electrode plate that are disposed substantially in parallel with the second surface, wherein
the negative electrode plate has a negative electrode active material layer including a Si-containing material as a negative electrode active material,
the negative electrode active material layer has
one or more closing plate side regions provided in a band shape at one or more end portions thereof on the closing plate side, and
a central region provided in a band shape at a center thereof in a first direction orthogonal to the closing plate, and
the closing plate side region is free of the Si-containing material or has a content of the Si-containing material lower than that in the central region.

2. The prismatic battery according to claim 1, wherein
the negative electrode active material layer further contains graphite as the negative electrode active material, and
the closing plate side region has a content of the graphite higher than that in the central region.

3. The prismatic battery according to claim 2, wherein
in the closing plate side region, a proportion of the Si-containing material in the total negative electrode active material is less than 20 mass %, and
in the central region, a proportion of the Si-containing material in the total negative electrode active material is 20 mass % or more.

4. The prismatic battery according to claim 1, wherein
the one or more openings of the case body comprise a single opening, while the one or more closing plates comprise a single closing plate,
the closing plate is opposed to the first surface,
the negative electrode active material layer further has a first surface side region provided in a band shape at an end portion thereof on the first surface side, and
the first surface side region is free of the Si-containing material or has a content of the Si-containing material lower than that in the central region.

5. The prismatic battery according to claim 4, wherein when an entire width of the negative electrode active material layer in the first direction is 100%, a ratio of a width of the closing plate side region and a ratio of a width of the first surface side region are each smaller than a ratio of a width of the central region.

6. The prismatic battery according to claim 5, wherein the ratio of the width of each of two of the closing plate side regions is 10% or more.

7. The prismatic battery according to claim 5, wherein
the laminated electrode assembly is disposed closer to the first surface than the closing plate in the first direction, and
the ratio of the width of the first surface side region is greater than the ratio of the width of the closing plate side region.

8. The prismatic battery according to claim 1, wherein
the one or more openings of the case body comprise two openings, while the one or more number of the closing plates comprise two closing plates,
the two closing plates are provided to be opposed to each other so as to be orthogonal to the first surface and the second surface, and
the closing plate side region is provided at each of the end portion on a first closing plate side and the end portion on a second closing plate side.

9. The prismatic battery according to claim 8, wherein when an entire width of the negative electrode active material layer in the first direction is 100%, a ratio of a width of each of two of the closing plate side regions is smaller than a ratio of a width of the central region.

10. The prismatic battery according to claim 9, wherein the ratio of the width of each of two of the closing plate side regions is 10% or more.
